(19) United States
(12) Patent Application Publication
(10) Pub. No.: US 2012/0152665 A1
(43) Pub. Date: Jun. 21, 2012

(54) Brake device for an exercise bicycle

(76) Inventor: Mu-Chuan Wu, Hsi-Kang Hsiang (TW)

(21) Appl. No.: 12/928,840

(22) Filed: Dec. 21, 2010

(51) Int. Cl. B60T 13/04; B60T 7/10

(52) U.S. Cl. 188/166

(57) ABSTRACT

A brake device for an exercise bicycle has a main tube, a resilient assembly and a driving assembly mounted axially in the main tube, a end cap mounted on an open end of the main tube, and a button attached to the driving assembly. The resilient assembly has a first resilient element and a second resilient element having a second coefficient of elasticity less than a first coefficient of elasticity of the first resilient element. The driving assembly presses against the first resilient element and is able to obviously and quickly adjust a pressure of the resilient element. The second resilient element quickly pushes the resilient assembly back and a resistance force applied to a wheel of the exercise bicycle is released.

### BACKGROUND OF THE INVENTION

1. Field of the Invention

The present invention relates to a brake device for an exercise bicycle, especially to a brake device having two resilient elements with different coefficients of elasticity.

2. Description of the Prior Art(s)

With reference to FIG. 7, an exercise bicycle comprises a frame 81, a wheel 83, a resistance device 82 and a conventional brake device 70. The wheel 83 is mounted rotatably on the frame 81. The resistance device 82 is mounted on the frame 81 and applies resistance to the wheel 83 to control an exercise load of a user when the user is riding the exercise bicycle. The conventional brake device 70 is mounted on the frame 80 and has an outer tube 71, a button 73, a driving shaft 72 and a spring 74. The outer tube 71 is mounted securely on the frame 81. The driving shaft 72 is mounted slidably through the outer tube 71 and has two ends protruding out of the outer tube 71 and connected respectively to the resistance device 82 and the button 73. The spring 74 is mounted in the outer tube 71 and has two ends respectively abutting the outer tube 71 and the driving shaft 72. When the button 73 and the driving shaft 72 are pushed, the spring 74 is pressed and the driving shaft 72 actuates the resistance device 82 to stop the wheel 83. When the button 73 and the driving shaft 72 are released, the spring 74 pulls the driving shaft 72 backwards.

However, the conventional brake device 70 only have one spring 74 to buffer a pushing force applied by the user and to push the driving shaft 72 back to release the resistance device 82. Considering to a buffering efficiency to the pushing force and a velocity when pushing the driving shaft 72 back, the spring 74 needs to have a moderate coefficient of elasticity. Furthermore, the coefficient of elasticity of the spring 74 is unadjustable to fit the user's need.

To overcome the shortcomings, the present invention provides a brake device for an exercise bicycle to mitigate or obviate the aforementioned problems.

### SUMMARY OF THE INVENTION

The main objective of the present invention is to provide a brake device for an exercise bicycle. The brake device for an exercise bicycle has a main tube, a resilient assembly and a driving assembly mounted axially in the main tube, a end cap mounted on an open end of the main tube, and a button attached to the driving assembly. The resilient assembly has a first resilient element and a second resilient element having a second coefficient of elasticity less than a first coefficient of elasticity of the first resilient element.

The driving assembly presses against the first resilient element and is able to obviously and quickly adjust a pressure of the resilient element. The second resilient element quickly pushes the resilient assembly back and a resistance force applied to a wheel of the exercise bicycle is released.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a brake device for an exercise bicycle in accordance with the present invention;

FIG. 2 is an exploded perspective view of the brake device in FIG. 1;

FIG. 3 is a side view in partial section of the brake device in FIG. 1;

FIG. 4 is an operational side view in partial section of the brake device in FIG. 1, shown pressed;

FIG. 5 is a side view in partial section of another embodiment of a brake device for an exercise bicycle in accordance with the present invention;

FIG. 6 is an operational side view in partial section of the exercise bicycle with the brake device in FIG. 1, shown connected to a resistance device of the exercise bicycle through transmission rods; and

FIG. 7 is an enlarged side view in partial section of an exercise bicycle with a conventional brake device in accordance with the prior art.

### DETAILED DESCRIPTION OF THE PREFERRED EMBODIMENTS

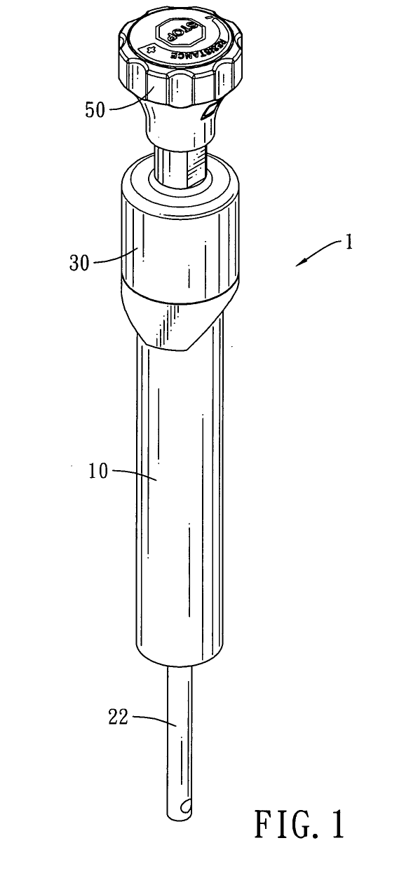

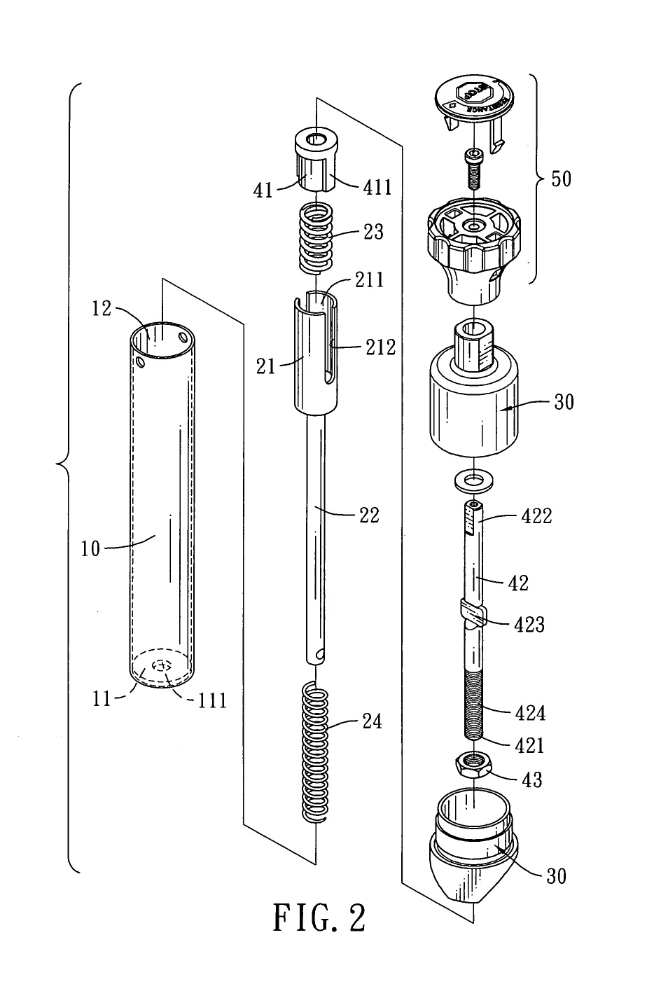

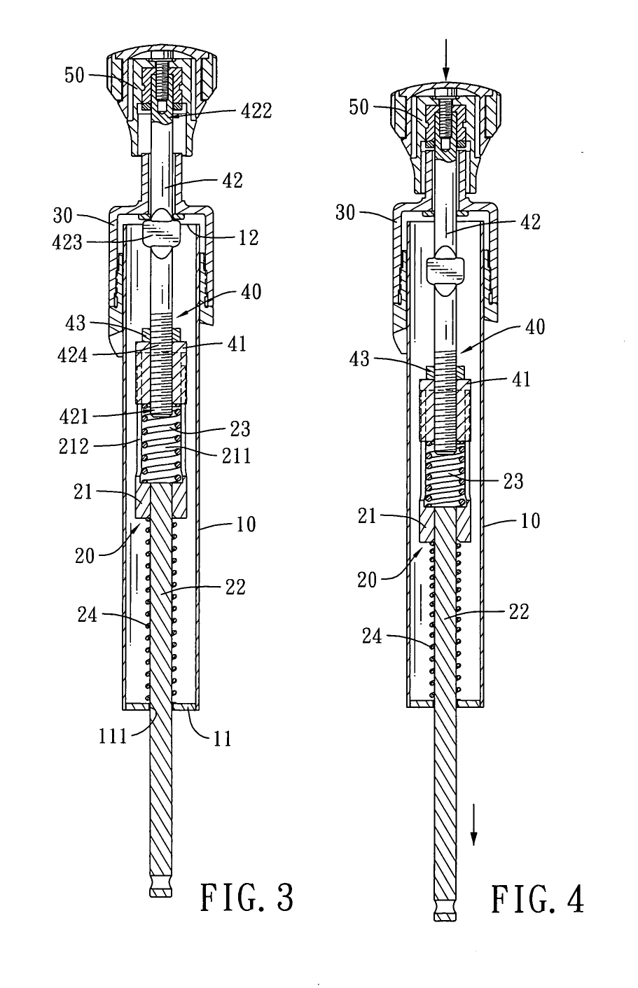

With reference to FIGS. 1 to 3 and 6, a brake device 1 for an exercise bicycle 60 in accordance with the present invention is mounted on a frame 61 of the exercise bicycle 60 and comprises a main tube 10, a resilient assembly 20, an end cap 30, a driving assembly 40 and a button 50.

The main tube 10 is tubular and has a closed end 11, an open end 12 and a through hole 111. The through hole 111 is formed through the closed end 11 of main tube 10.

The resilient assembly 20 is mounted axially in the main tube 10 and has a support 21, an extending shaft 22, a first resilient element 23 and a second resilient element 24. The support 21 has a mounting recess 211, a sidewall and at least one guiding slit 212. The mounting recess 211 is formed in an upper end of the support 21. The sidewall is defined around the mounting recess 211. The at least one guiding slit 212 is formed through the sidewall of the support 21 and extends axially. The extending shaft 22 protrudes axially from a lower end of the support 21, is thinner than the support 21 and is mounted slidably through the through hole 111 of the main tube 10. The first resilient element 23 may be a compression spring, is mounted in the mounting recess 211 of the support 21 and has a first coefficient of elasticity. The second resilient element 24 may be a compression spring, is mounted around the extending shaft 22 and has two ends and a second coefficient of elasticity. The ends of the second resilient element 24 respectively abut the lower end of the support 21 and the closed end 11 of the main tube 10. The second coefficient of elasticity of the second resilient element 24 is less than the first coefficient of elasticity of the first resilient element 23.

The end cap 30 is mounted securely on the open end 12 of the main tube 10.

The driving assembly 40 is mounted axially through the end cap 30, presses against the first resilient element 23 and has a slider 41, a driving shaft 42 and a stopper 43.

The slider 41 is mounted slidably in the mounting recess 211 of the support 21, presses against the first resilient element 23 and has a lower end, an upper end and at least one sliding protrusion 411. The lower end of the slider 41 presses against the first resilient element 23. The at least one sliding protrusion 411 is formed on a side surface of the slider 41 and slidably protrudes in the at least one guiding slit 212 of the support 21. Thus, the slider 41 slides axially in the mounting recess 211 of the support 21 and does not rotate relative to the support 21.

The driving shaft 42 has an inner section 421, an outer section 422, a limit protrusion 423 and an outer thread 424. The inner section 421 of the driving shaft 42 is mounted through the slider 41. The outer section 422 of the driving shaft 42 is mounted through and protrudes out of the end cap 50. The limit protrusion 423 is formed on the driving shaft 42, is disposed between the inner and outer sections 421, 422 and in the main tube 10, and selectively abuts the end cap 30 so the driving shaft 42 does not slip out of the main tube 10 and the end cap 30. The outer thread 424 is formed on and around the inner section 421 of the driving shaft 42.

The stopper 43 is mounted adjustably on the inner section 421 of the driving shaft 42, abuts the upper end of the slider 41, and may be a screw nut and adjustably and securely engages the outer thread 424 of the driving shaft 42.

The button 50 is attached to the outer section 422 of the driving shaft 42.

The brake device for the exercise bicycle as described has the following advantages. Turning the stopper 43 adjusts the positions of the stopper 43 and the slider 41. Consequently, a pressure of the first resilient element 23 is adjusted. Furthermore, since the first coefficient of elasticity of the first resilient element 23 is larger than the second coefficient of elasticity of the second resilient element 24, adjusting the position of the stopper 43 obviously and quickly adjusts the pressure of the first resilient element 23.

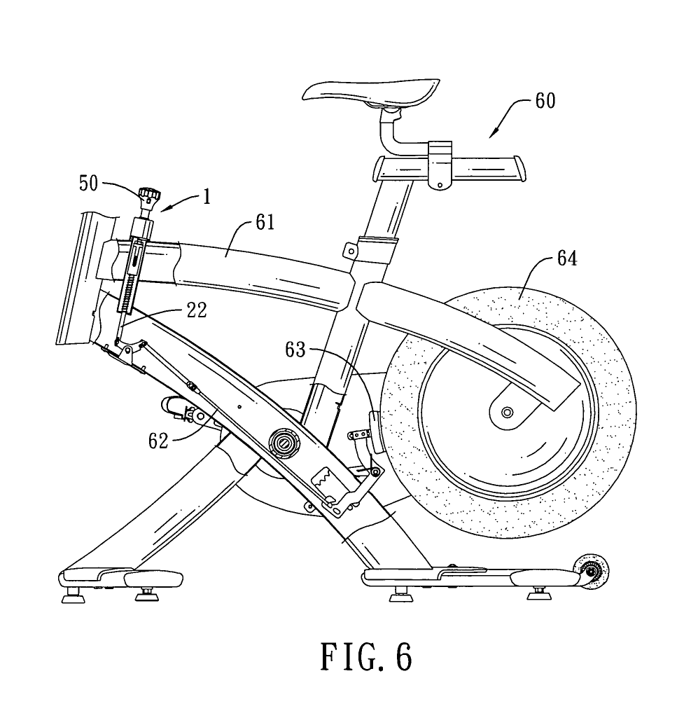

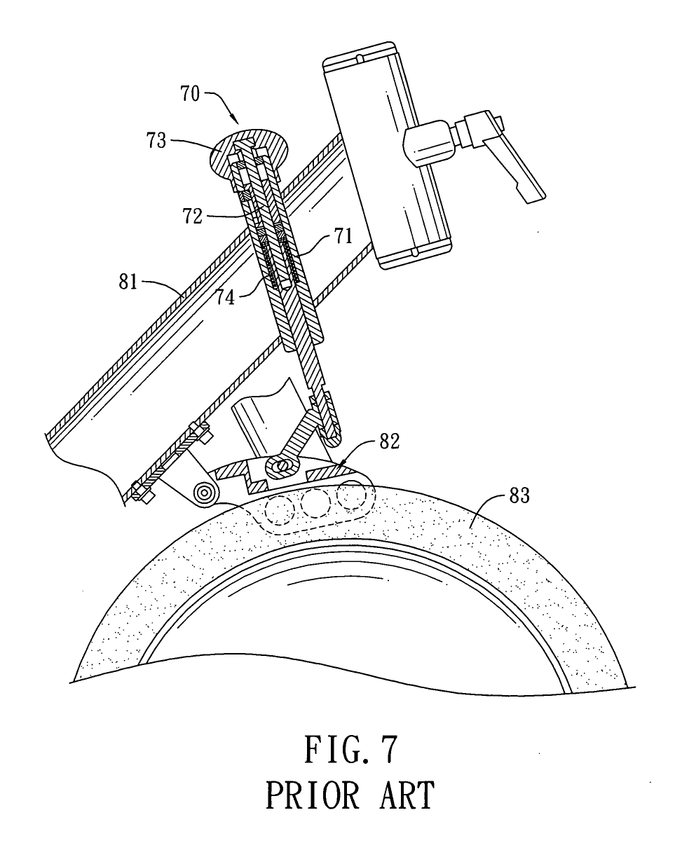

With further reference to FIG. 6, the extending shaft 22 of the resilient assembly 20 is connected to a resistance device 63 of the exercise bicycle 60 through transmission rods 62. The resistance device 63 corresponds to and applies a resistance force to a wheel 64 of the exercise bicycle 60. The resistance force applied to the wheel 64 is adjustable and may slow down rotation of the wheel 64 or stop the wheel 64 from rotating.

With further reference to FIG. 4, when a user pushes the button 50, the driving shaft 42, the slider 41, the support 21 and the extending shaft 22, the first and second resilient elements 23, 24 are pressed simultaneously.

Then, the extending shaft 22 actuates the resistance device 63 through the transmission rods 62 to slow down the rotation of the wheel 64 or to stop the wheel 64 from rotating. Furthermore, since the second resilient element 24 is pressed and has less coefficient of elasticity, as the user releases the button 50, the second resilient element 24 quickly pushes the support 21 and the extending shaft 22 back and the resistance force applied to the wheel 64 is released.

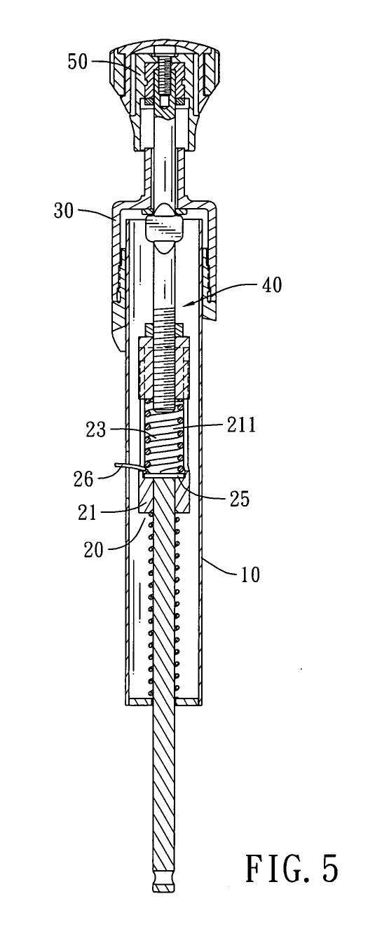

With further reference to FIG. 5, in another embodiment, the resilient assembly 20 further has a pressure sensing patch 26 mounted in the mounting recess 211 of the support 21. The first resilient element 23 is mounted on and presses against the pressure sensing patch 26. Thus, the pressure sensing patch 26 senses the pressure of the first resilient element 23 and then shows the pressure of the first resilient element 23 on an instrument panel to allow the user to pay attention to the pressure of the first resilient element 23 to see if the pressure of the first resilient element 23 needs adjustment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A brake device for an exercise bicycle comprising
a main tube having
a closed end;
an open end; and
a through hole formed through the closed end of main tube;
a resilient assembly mounted axially in the main tube and having
a support having a mounting recess formed in an upper end of the support;
an extending shaft protruding axially from a lower end of the support, being thinner than the support and mounted slidably through the through hole of the main tube;
a first resilient element mounted in the mounting recess of the support and having a first coefficient of elasticity; and
a second resilient element mounted around the extending shaft and having
two ends respectively abutting the lower end of the support and the closed end of the main tube; and
a second coefficient of elasticity being less than the first coefficient of elasticity of the first resilient element;
an end cap mounted securely on the open end of the main tube;
a driving assembly mounted axially through the end cap, pressing against the first resilient element and having
a slider mounted slidably in the mounting recess of the support, pressing against the first resilient element and having
a lower end pressing against the first resilient element; and
an upper end;
a driving shaft having
an inner section mounted through the slider;
an outer section mounted through and protruding out of the end cap; and
a limit protrusion formed on the driving shaft, disposed between the inner and outer sections and in the main tube, and selectively abutting the end cap; and
a stopper mounted adjustably on the inner section of the driving shaft and abutting the upper end of the slider; and
a button attached to the outer section of the driving shaft.

2. The brake device as claimed in claim 1, wherein
the resilient assembly further has a pressure sensing patch mounted in the mounting recess of the support; and
the first resilient element is mounted on and presses against the pressure sensing patch.

3. The brake device as claimed in claim 1, wherein
the driving shaft further has outer thread formed on and around the inner section of the driving shaft; and
the stopper is a screw nut and adjustably and securely engages the outer thread of the driving shaft.

4. The brake device as claimed in claim 2, wherein
the driving shaft further has outer thread formed on and around the inner section of the driving shaft; and
the stopper is a screw nut and adjustably and securely engages the outer thread of the driving shaft.

5. The brake device as claimed in claim 1, wherein
the support further has
a sidewall defined around the mounting recess; and
at least one guiding slit formed through the sidewall of the support and extending axially; and
the slider further has at least one sliding protrusion formed on a side surface of the slider and slidably protruding in the at least one guiding slit of the support.

6. The brake device as claimed in claim 2, wherein
the support further has
a sidewall defined around the mounting recess; and
at least one guiding slit formed through the sidewall of the support and extending axially; and
the slider further has at least one sliding protrusion formed on a side surface of the slider and slidably protruding in the at least one guiding slit of the support.

7. The brake device as claimed in claim 3, wherein
the support further has
a sidewall defined around the mounting recess; and
at least one guiding slit formed through the sidewall of the support and extending axially; and
the slider further has at least one sliding protrusion formed on a side surface of the slider and slidably protruding in the at least one guiding slit of the support.

8. The brake device as claimed in claim 4, wherein
the support further has
a sidewall defined around the mounting recess; and
at least one guiding slit formed through the sidewall of the support and extending axially; and
the slider further has at least one sliding protrusion formed on a side surface of the slider and slidably protruding in the at least one guiding slit of the support.

9. The brake device as claimed in claim 5, wherein the first and second resilient elements are compression springs.

10. The brake device as claimed in claim 6, wherein the first and second resilient elements are compression springs.

11. The brake device as claimed in claim 7, wherein the first and second resilient elements are compression springs.

12. The brake device as claimed in claim 8, wherein the first and second resilient elements are compression springs.
